(19) United States
(12) Patent Application Publication
(10) Pub. No.: US 2025/0365213 A1
(43) Pub. Date: Nov. 27, 2025

(54) ENHANCEMENTS TO THE 3GPP SYSTEM TO MAP TRAFFIC CATEGORIES TO APPLICATION AI/ML OPERATION TYPES

(71) Applicant: InterDigital Patent Holdings, Inc., Wilmington, DE (US)

(72) Inventors: Ulises Olvera-Hernandez, Saint-Lazare (CA); Michael Starsinic, Newtown, PA (US); Achref Methenni, Montreal (CA); Morteza Kheirkhah, London (GB); Jung Je Son, Warrington, PA (US); Zhibi Wang, Woodridge, IL (US)

(73) Assignee: InterDigital Patent Holdings, Inc., Wilmington, DE (US)

(21) Appl. No.: 19/108,092

(22) PCT Filed: Sep. 29, 2023
(86) PCT No.: PCT/US23/75510

§ 371 Date: Feb. 28, 2025

Related U.S. Application Data
(60) Provisional application No. 63/411,284, filed on Sep. 29, 2022.
(60) Provisional application No. 63/517,726, filed on Aug. 4, 2023.

(51) Int. Cl. H04L 41/16; H04W 8/22; H04W 40/12; H04W 48/18

(52) U.S. Cl. CPC H04L 41/16; H04W 8/22; H04W 40/12; H04W 48/18

(57) ABSTRACT

A wireless transmit/receive unit (WTRU) may receive a configuration. The configuration may include at least one of an artificial intelligence machine learning (AI/ML) operation type association to a traffic category. The traffic category may correspond to an AI/ML operation traffic category and/or at least one parameter. The WTRU may determine an AI/ML service operation type, for example to be operated by an AI/ML application client on the WTRU. The WTRU may transmit, for example to a network element, a request for analytics and/or a prediction related to the AI/ML service operation type. The request may include an indication of the traffic category and/or the at least one parameter. The WTRU may receive the analytics and/or prediction related to the AIMML service operation type, for example in response to the request.

### CROSS-REFERENCE TO RELATED APPLICATIONS

This application claims the benefit of U.S. Provisional Application No. 63/411,284 filed on Sep. 29, 2022 and 63/517,726 filed on Aug. 4, 2023, the entire contents of each of which are incorporated herein by reference.

### BACKGROUND

Traffic categories may represent traffic generated by applications, such as gaming, video streaming, and applications related to enterprise services. Traffic categories can be included in wireless transmit/receive unit (WTRU) RSP (WTRU Route Selection Policies) within traffic descriptors.

### SUMMARY

Described herein are embodiments for providing a mapping of traffic categories to application artificial intelligence (AI)/machine learning (ML) (AI/ML) operation types.

Described herein are embodiments for providing the use of UE route selection policy (URSP) rules to match Traffic categories and/or connection capabilities to application traffic that can be further filtered using ancillary parameters, for example connection capability, operating system identifier (OSid), application identifier (AppID), and/or single-network slice assistance information (S-NSSAI)/data network name (DNN) (S-NSSAI/DNN).

Described herein may include the application client in the wireless transmit/receive unit (WTRU), which may receive mapping of application AI/ML operation type(s) to traffic category and/or connection capability and/or ancillary parameter (e.g., AppID) through the application layer and/or the WTRU may use the mapping when requesting a connection from the NAS layer.

The WTRU may match the traffic category and/or connection capability provided by the AI/ML application client to the associated URSP rule and/or may use the matched traffic category value to request analytics and/or predictions from the 5G core (5GC).

The session management function (SMF) may use traffic category and/or connection capability and/or ancillary parameters, received from the WTRU, to identify the relevant analytic IDs the WTRU is requesting. The SMF may use one or more of the parameters to fetch the relevant analytics from the unified data management (UDM).

A WTRU (e.g., a WTRU that hosts an application client) may use URSP rules to, and/or information that is obtained from the application client, for example, to determine the characteristics of a protocol data unit (PDU) session that can be used by the application client to perform AI/ML operations. A WTRU (e.g., a WTRU that hosts an application client) may use URSP rules to obtain (e.g., from the network), for example by using a traffic category and/or connection capability, a list of analytics IDs that are accessible to the application client. The list may be provided to the application client.

A WTRU may receive a configuration. The configuration may include at least one of an artificial intelligence machine learning (AI/ML) operation type association to a traffic category. The traffic category may correspond to an AI/ML operation traffic category and/or at least one parameter. The WTRU may determine an AI/ML service operation type, for example to be operated by an AI/ML application client on the WTRU. The WTRU may transmit, for example to a network element, a request for analytics and/or a prediction related to the AI/ML service operation type. The request may include an indication of the traffic category and/or the at least one parameter. The WTRU may receive the analytics and/or prediction related to the AI/ML service operation type, for example in response to the request.

The WTRU may match the AI/ML service operation type to the traffic category or the at least one parameter, for example based on the configuration. The at least one parameter may be related to traffic generated by one or more client applications on the network. The WTRU may match the AI/ML service operation type to the traffic category and/or the at least one parameter, for example based on a route selection policy (RSP) rule matched against a traffic category. The traffic category may indicate at least one AI/ML value. The at least one AI/ML value may indicate at least one of a model distribution value, a federated learning value, and/or an operation split value.

The traffic category may include the at least one parameter. The at least one parameter may include an application descriptor and/or a connection capability parameter that, for example may be associated with an AI/ML value. The analytics and/or prediction may indicate a quality of service (QOS) of the traffic to be generated by the client applications on the network over a period of time.

The WTRU may receive mapping of the AI/ML operation type over the user plane. The WTRU may receive mapping of the AI/ML operation type from an application function (AF). The at least one parameter may include at least one of a connection capability, an OSid, an App ID, and/or an S-NSSAI/DNN. The WTRU may determine a route selection policy based on the analytics and/or prediction, for example related to the AI/ML service operation type.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A is a schematic illustration of an example system environment that may implement an AI/ML model.

FIG. 2B illustrates an example of a neural network.

FIG. 2C is a schematic illustration of an example system environment for training and implementing an AI/ML model that comprises an NN.

FIG. 3 is an example flow diagram of a system to request network data analytics.

FIGS. 4A and 4B depict an example of the WTRU RSP based configuration of traffic categories to application traffic.

### DETAILED DESCRIPTION

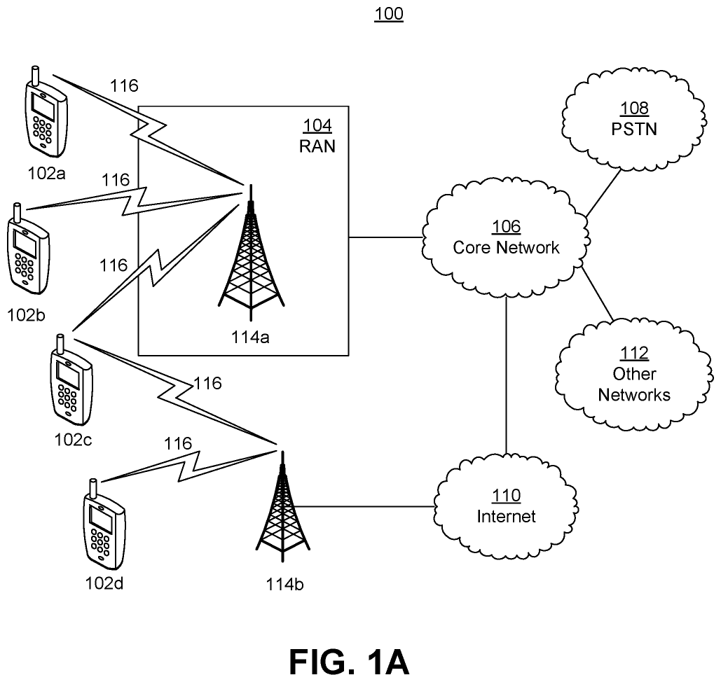

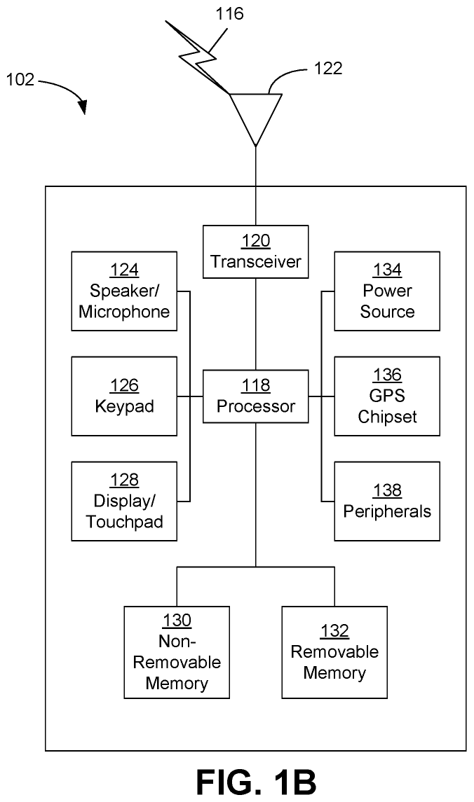

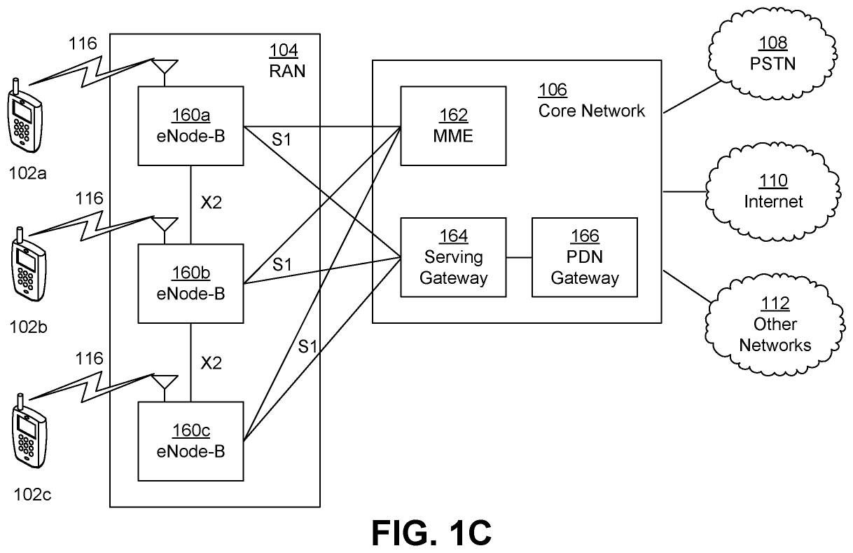

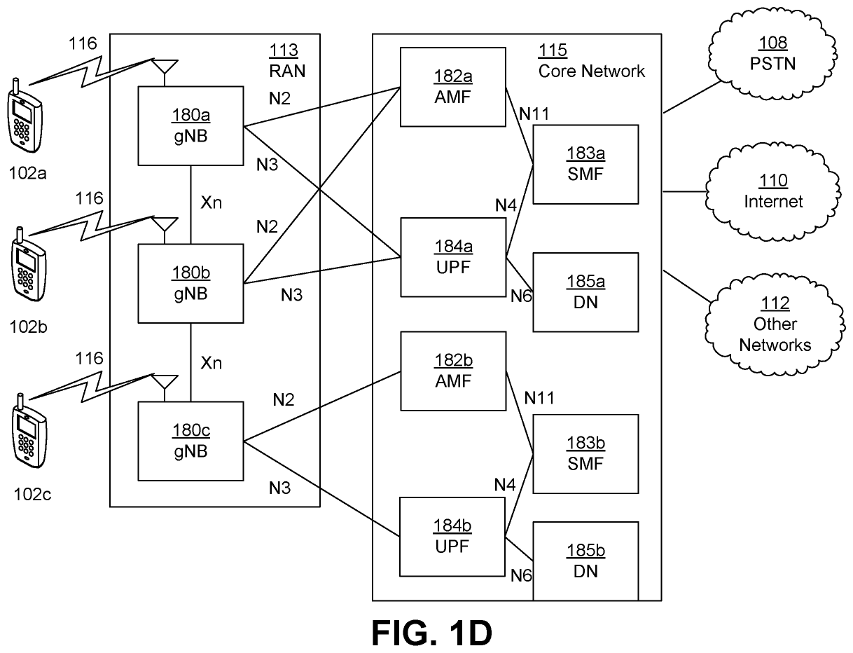

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel.

The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and/or apparatus described herein may implement artificial intelligence (AI) and/or machine learning (ML) (AI/ML). For example, one or more devices in the communication system 100 may implement AI/ML. One or more of the WTRUs 102a, 102b, 102c, 102d, the RAN 104/113, and/or the CN 106/115 may implement AI/ML. Additionally, other WTRUs, base stations, and/or network elements may implement AI/ML.

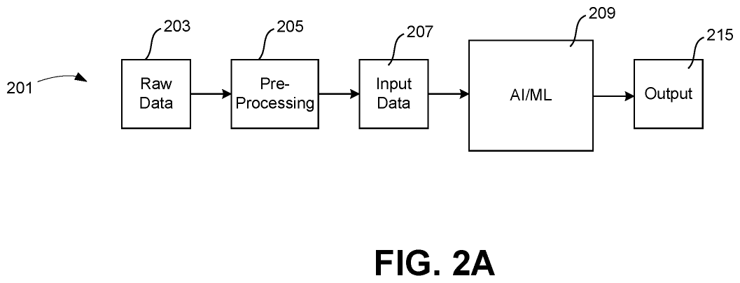

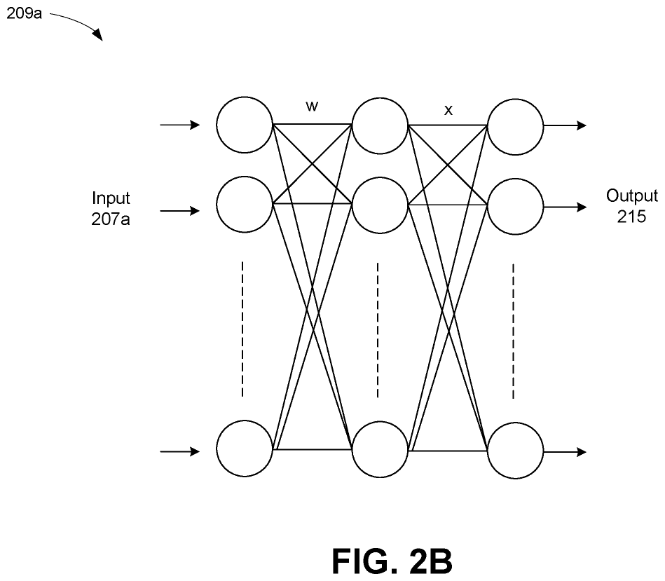

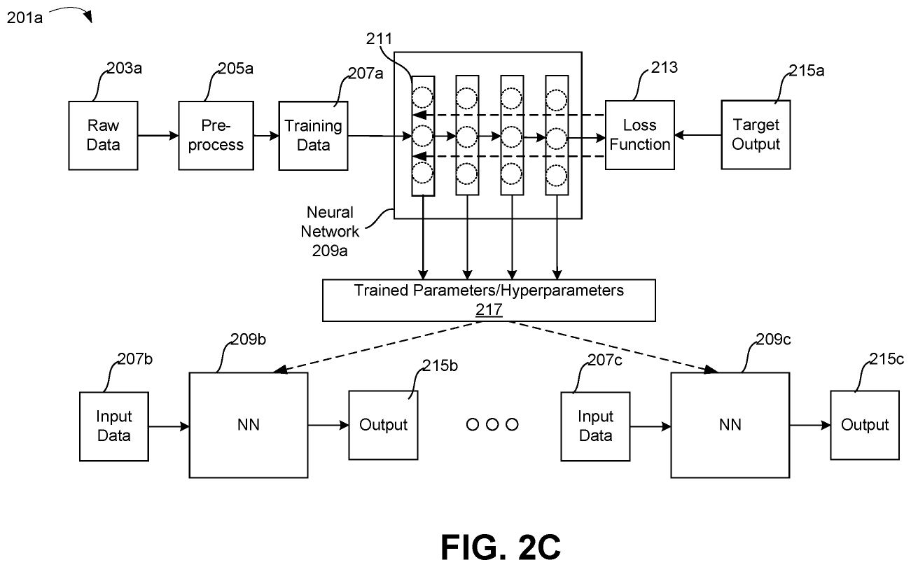

FIG. 2A is a schematic illustration of an example system environment 201 that may implement an AI/ML 209 model. The AI/ML 209 model may include model data and one or more algorithms and/or functions configured to learn from input data 207 that is received to train the AI/ML 1209 and/or generate an output 215. The input data 207 may be input in one or more formats, such as an image format, an audio format (e.g., spectrogram or other audio format), a tensor format (e.g., including single-dimensional or multi-dimensional arrays), and/or another data type capable of being input into the AI/ML 209 algorithms. The input data 207 may be the result of pre-processing 205 that may be performed on raw data 203, or the input data 207 may include the raw data 203 itself. The raw data 103 may include image data, text data, audio data, or another sequence of information, such as a sequence of network information related to a communication network, and/or other types of data. The pre-processing 205 may include format changes or other types of processing in order to generate input data 207 in a format for being input into the AI/ML 209 algorithms. For example, image data (e.g., including video data) and/or audio data may be raw data 203 that may be pre-processed during pre-processing 205 to generate the input data 207 in a format configured to be received by the AI/ML 209 algorithm. Input data 207, for the generation output may include one or more of a WTRU location (e.g., when the analytics were requested), a WTRU identity (e.g., GPSI), and/or mobility registration update data. Mobility registration update data may include periodicity of registrations. A network function may request analytics, for example from a NWDAF, to generate WTRU mobility statistics and/or predictions, and/or to generate an algorithm that runs an ML model. The mobility statistics and/or predictions, and/or the algorithm that runs an ML model may be executed by the NWDAF, for example to obtain (e.g., requested) analytics. The network function may be in a 3GPP 5G System. The NWDAF may collect/determine algorithms to execute (e.g., whether a federated learning operation is warranted) and/or the (e.g., required) input data. The input data may be collected from (e.g., relevant) NFs. The NWDAF may collect/determine the algorithms and/or input data from (e.g., by looking at) the analytics ID and/or other ancillary parameters (e.g., the target for analytics reporting), for example provided by the entity that requests statistics and/or predictions. A network entity, for example one or more of a gNB, a WTRU, and/or a NF (e.g., that requires network analytics from NWDAF), may request the network analytics. The network entity may request the network analytics by providing/sending an analytic ID. For example, the analytic ID may be set to UE Mobility. A WTRU may request network analytics from the 5G system, for example to determine the characteristics of a data connection. The data connection may be used for ML mode distribution, for example part of a federated learning operation. There may be requests for multiple network analytics. The WTRU may provide input data, for example including one or more of an AI/ML operation/type/characteristic, a traffic category, and/or a connection capability. The AI/ML algorithm 209 may generate output. The output 215 may be generated by the AI/ML 209 algorithm in one or more formats, such as a tensor, a text format (e.g., a word, sentence, or other sequence of text), a numerical format (e.g., a prediction), an audio format, an image format (e.g., including video format), another data sequence format, or/another output format. The AI/ML algorithm 209 may predict and/or infer the WTRU mobility analytics. Output 215 may include one or more of the geographical distribution of WTRUs amongst tracking areas (TA) and/or cells, and/or the direction of the WTRU movement in the coverage area. Output 215 may additionally, or alternatively, include one or more analytics and/or predictions, for example as described herein.

AI/ML may be implemented as described herein using software and/or hardware. The AI/ML may be stored as computer-executable instructions on computer-readable media accessible by one or more processors for performing as described herein. Example AI/ML environments and/or libraries include TENSORFLOW, TORCH, PYTORCH, MATLAB, GOOGLE CLOUD AI and AUTOML, AMAZON SAGEMAKER, AZURE MACHINE LEARNING STUDIO, and/or ORACLE MACHINE LEARNING.

The AI/ML 209 may include one or more algorithms configured for unsupervised learning. Unsupervised learning may be implemented utilizing AI/ML 209 algorithms that learn from the input data 207 without being trained toward a particular target output. For example, during unsupervised learning the AI/ML 209 algorithms may receive unlabeled data as input data 207 and determine patterns or similarities in the input data 207 without additional intervention (e.g., updating parameters and/or hyperparameters). The AI/ML 209 algorithms that are configured for implementing unsupervised learning may include algorithms configured for identifying patterns, groupings, clusters, anomalies, and/or similarities or other associations in the input data 207. For example, the AI/ML may implement hierarchical clustering algorithms, k-means clustering algorithms, k nearest neighbors (K-NN) algorithms, anomaly detection algorithms, principal component analysis algorithms, and/or apriori algorithms. An autoencoder may be a form of AI/ML 209 that may be implemented for unsupervised learning. The autoencoder may include an encoder configured to transform the input data 207 and/or a decoder that may recreate the input data from the data received by the encoder. The autoencoder may be implemented for processing image data and/or other forms of input data. The AI/ML 209 algorithms configured for unsupervised learning may be implemented on a single device or distributed across multiple devices, such that the output 215, or portions thereof, may be aggregated at one or more devices for being further processed and/or implemented in other downstream algorithms or processes, as may be further described herein.

The AI/ML 209 may include one or more algorithms configured for supervised learning. Supervised learning may be implemented utilizing AI/ML 209 algorithms that are trained during a training process to determine a predictive model using known outcomes. The AI/ML 209 algorithms may be characterized by parameters and/or hyperparameters that may be trained during the training process. The parameters may include values derived during the training process. The parameters may include weights, coefficients, and/or biases. The AI/ML 209 may also include hyperparameters. The hyperparameters may include values used to control the learning process. The hyperparameters may include a learning rate, a number of epochs, a batch size, a number of layers, a number of nodes in each layer, a number of kernels (e.g., CNNs), a size of stride (e.g., CNNs), a size of kernels in a pooling layer (e.g., CNNs), and/or other hyperparameters. Some may use certain parameters and hyperparameters interchangeably.

The AI/ML 209 may be trained during supervised learning by inputting training data to the AI/ML 209 algorithm and adjusting the parameters and/or hyperparameters toward a known target output 215 while minimizing a loss or error in the output 215 generated by the AI/ML 209 algorithm. The raw data 203 may include or be separated into training data, validation data, and/or test data for training, validation, and/or testing, respectively, the AI/ML 209 algorithms during supervised learning. The training data, validation data, and/or test data may be pre-processed from the raw data 203 for being input into the AI/ML 209 algorithm. During supervised learning, the training data may be labeled prior to being input into the AI/ML 209. The training data may be labeled to teach the AI/ML 209 algorithm to learn from the labeled data and to test the accuracy of the AI/ML 209 for being implemented on unlabeled input data 207 during production/implementation of the AI/ML 209 algorithms, or similar AI/ML 209 algorithms utilizing similar parameters and/or hyperparameters. The training data may be used to fit the parameters of the AI/ML 209 model using optimization functions, such as a loss or error function. Often the training data includes pairs of input data 207 and a corresponding target output 215 to which the parameters may be trained to generate (e.g., within a threshold loss or error). The trained or fitted AI/ML 209 model may receive the validation data as input to evaluate the model fit on the training data set, while tuning the hyperparameters of the AI/ML 209 model. The AI/ML 209 model may receive the test data to evaluate a final model fit on the training data set and to assess the performance of the AI/ML 209 model. One or more of the training, validation, and/or testing may be performed during supervised learning for different types of AI/ML 209 models.

Supervised learning may be implemented for various types of AI/ML 209 algorithms, including algorithms that implement linear regression, logistic regression, neural networks (NNs), decision trees, Bayesian logics, random forests, and/or support vector machines (SVMs). NNs and Deep NNs (DNNs) are popular examples of algorithms utilized in AI/ML models that may be trained using supervised learning. However, the AI/ML 209 models may implement one or more NN and/or non-NN-based algorithms. Various examples of NNs include: perceptrons, multilayer perceptrons (MLPs), feed-forward NNs, fully-connected NNs, convolutional Neural Networks (CNNs), recurrent NNs (RNNs), long-short term memory (LSTM) NNs, and/or residual NNs (ResNets). A perceptron is a NN that includes a function that multiplies its input by a learned weight coefficient to generate an output value. A feed-forward NN is a NN that receives input at one or more nodes of an input layer and moves information in a direction through one or more hidden layers to one or more nodes of an output layer. In a feed-forward NN, one or more nodes of a given layer may be connected to one or more nodes of another layer. A fully connected NN is a NN that includes an input layer, one or more hidden layers, and an output layer. In a fully connected NN, each node in a layer is connected to each node in another layer of the NN. An MLP is a fully connected class of feed-forward NNs. A CNN is a NN having one or more convolutional layers configured to perform a convolution. Various types of NNs may have elements that include one or more CNNs or convolutional layers, such as Generative Adversarial Networks (GANs). GANs may include conditional GANs (CGANS), cycle-consistent GANs (CycleGANs), StyleGANs, DiscoGANs, and/or IsGANs. A GAN may include a generator sub-model and a discriminator sub-model. The generator sub-model may be configured to receive input data and pass true and independently generated data to the discriminator sub-model. The discriminator sub-model may be configured to receive the true and independently generated data from the generator, discriminate the true and independently generated data, and provide feedback to the generator sub-model during training to improve the function of the generator sub-model in independently generating an output based on a received input. The GAN is a popular model for generating data types or data sequences, such as image data, audio data, and/or text, for example. An RNN is a NN that is recurrent in nature, as the nodes include feedback connections and an internal hidden state (e.g., memory) that allows output from nodes in the NN to affect subsequent input to the same nodes. LSTM NNs may be similar to RNNs in that the nodes have feedback connections and an internal hidden state (e.g., memory). However, the LSTM NNs may include additional gates to allow the LSTM NNs to learn longer-term dependencies between sequences of data. A ResNet is a NN that may include skip connections to skip one or more layers of the NN. An autoencoder may be a form of AI/ML 209 that may be implemented for supervised learning, such that parameters and/or hyperparameters may be updated during a training procedure. The parameters and/or hyperparameters may relate to the encoder portion and/or the decoder portion of the autoencoder. Some NNs include one or more attention layers or functions to enhance or focus on some portions of the input data, while diminishing or de-emphasizing other portions.

Different types of NNs and/or layers may be implemented for processing different types of data and/or producing different types of output. For example, the NN may comprise one or more convolutional layers (e.g., for CNNs or GANs), which may be popular for processing image data and/or audio data (e.g., spectrograms). Each convolutional layer may vary according to various convolutional layer parameters or hyperparameters, such as kernel size (e.g., field of view of the convolution), stride (e.g., step size of the kernel when traversing an image), padding (e.g., for processing image borders), and/or input and output size. The image being processed may include one or more dimensions (e.g., a line of pixels or a two-dimensional array of pixels). The pixels may be represented according to one or more values (e.g., one or more integer values representing color and/or intensity) that may be received by the convolutional layer. The kernel, which may also be referred to as a convolution matrix or mask, may be a matrix used to extract and/or transform features from the input data being received. The kernel may be used for blurring, sharpening, edge detection, and/or the like. An example kernel size may include a 3×3, 5×5, 10×10, etc. matrix (e.g., in pixels for a 2D image). The stride may be the parameter used to identify the amount the kernel is moved over the image data. An example default stride is of a size of 1 or 2 within the matrix (e.g., in pixels for a 2D image). The padding may include the amount of data (e.g., in pixels for a 2D image) that is added to the boundaries of the image data when it is processed by the kernel. The kernel may be moved over the input image data (e.g., according to the stride length) and perform a dot product with the overlapping input region to obtain an activation value for the region. The output of each convolutional layer may be provided to a next layer of the NN or provided as an output (e.g., image data, feature map, etc.) of the NN itself with the updated features based on the convolution.

The NN may include layers of a similar type (e.g., convolutional layers, feed-forward layers, fully-connected layers, etc.) and/or having a similar or different configuration (e.g., size, number of nodes, etc.) for each layer. The NN may also, or alternatively, include one or more layers having different types or different subsets of NNs that may be interconnected for training and/or implementation, as described herein. For example, a NN may include both convolutional layers and feed-forward or fully-connected layers.

FIG. 2B illustrates an example of a neural network 209a. The objective of training may be to apply the input 207a as training data and/or adjust one or more weights, indicated as w and x in FIG. 2B (e.g., which may be referred to as neuron weights and/or link weights), such that the output 215 from the neural network 209a approaches the desired target values which are associated with the input 207a values for the training data. In examples, a neural network may include three layers (e.g., as shown in FIG. 2B). During the training, for given input, the difference between output and desired values may be computed and/or the difference may be used to update the one or more weights in the neural network. If a significant (e.g., large) difference between output and desired value(s) is observed, for example, one or more relatively significant (e.g., large) changes in one or more weights may be expected. A small difference (e.g., between output and desired value(s) may include one or more relatively small changes in one or more weights.

Training a neural network 209a may include identifying one or more of the following information: the input for the neural network; the expected output associated with the input; and/or the actual output from the neural network against which the target values are compared.

In examples, a neural network model may be characterized by one or more parameters and/or hyperparameters, which may include: the number of weights and/or the number of layers in the neural network.

As used herein, the term “deep learning” may refer to a class of machine learning algorithms that employ artificial neural networks (e.g., deep neural networks (DNNs) which were loosely inspired from biological systems and/or include at least one hidden layer. DNNs may be a special class of machine learning models inspired by the human brain where the input is linearly transformed and/or pass through a non-linear activation function one or more (e.g., multiple) times. DNNs may include one or more (e.g., multiple) layers where one or more (e.g., each) layer includes linear transformation and/or a given non-linear activation function(s). The DNNs may be trained using the training data via a back-propagation algorithm.

FIG. 2C is a schematic illustration of an example system environment 201a for training and implementing an AI/ML 209 model that comprises an NN 209a. However, other types of AI/ML models (e.g., including NNs and/or non-NN models) may be similarly trained and/or implemented. The NN 209a may be trained and/or implemented on one or more devices to determine and/or update parameters and/or hyperparameters 217 of the NN 209a. Raw data 203a may be generated from one or more sources. For example, the raw data 203 may include image data, text data, audio data, or another sequence of information, such as a sequence of network information related to a communication network, and/or other types of data. The raw data 203 may be preprocessed at 105a to generate training data 207a. The preprocessing may include formatting changes or other types of processing in order to generate the training data 207a in a format for being input into the NN 109a.

The NN 209a may include one or more layers 211. The configuration of the NN 209a and/or the layers 211 may be based on the parameters and/or hyperparameters 217. As described herein, the parameters may include weights, or coefficients, and/or biases for the nodes or functions in the layers 211. The hyperparameters may include a learning rate, a number of epochs, a batch size, a number of layers, a number of nodes in each layer, a number of kernels (e.g., CNNs), a size of stride (e.g., CNNs), a size of kernels in a pooling layer (e.g., CNNs), and/or other hyperparameters. As described herein, the NN 209a may include a feed forward NN, a fully connected NN a CNN, a GAN, an RNN, a ResNet, and/or one or more other types of NNs. The NN 209a may be comprised of one or more different types of NNs or different layers for different types of NNs. For example, the NN 209a may include one or more individual layers having one or more configurations.

During the training process, the training data 207a may be input into the NN 209a and may be used to learn the parameters and/or tune the hyperparameters 217. The training may be performed by initializing parameters and/or hyperparameters of the NN 209a, generating and/or accessing the training data 207a, inputting the training data 207a into the NN 209a, calculating the error or loss from the output of the NN 209a to a target output 215a via a loss function 213 (e.g., utilizing gradient descent and/or associated back propagation), and/or updating the parameters and/or hyperparameters 217.

The loss function 213 may be implemented using backpropagation-based gradient updates and/or gradient descent techniques, such as Stochastic Gradient Descent (SGD), synchronous SGD, asynchronous SGD, batch gradient descent, and/or mini-batch gradient descent. Examples of loss or error functions may include functions for determining a squared-error loss, a mean squared error (MSE) loss, a mean absolute error loss, a mean absolute percentage error loss, a mean squared logarithmic error loss, a pixel-based loss, a pixel-wise loss, a cross-entropy loss, a log loss, and/or a fiducial-based loss. The loss functions may be implemented in accordance one or more quality metrics, such as a Signal to Noise Ratio (SNR) metric or another signal or image quality metric.

An optimizer may be implemented along with the loss function 213. The optimizer may be an algorithm or function that is configured to adapt attributes of the NN 209a, such as a learning rate and/or weights, to improve the accuracy of the NN 209a and/or reduce the loss or error. The optimizer may be implemented to update the parameters and/or hyperparameters 217 of the NN 209a.

The training process may be iterated to update the parameters and/or hyperparameters 117 until an end condition is achieved. The end condition may be achieved when the output of the NN 109a is within a predefined threshold of the target output 215a.

After the training process is complete, the trained NN 209a, or portions thereof, may be stored for being implemented by one or more devices. The trained NN 209a, or portions thereof, may be implemented in other downstream algorithms or processes, as may be further described herein. The trained NN 209a, or portions thereof, may be implemented on the same device on which the training was performed. The trained NN 209a, or portions thereof, may be transmitted or otherwise provided to another device for being implemented. For example, the NN 209b, 209c may include one or more portions of the trained NN 209a. The NN 209b and NN 209c receive respective input data 207b, 207c and to generate respective outputs 215b, 215c. The output 215b, 215c may be generated in one or more formats, such as a tensor, a text format (e.g., a word, sentence, or other sequence of text), a numerical format (e.g., a prediction), an audio format, an image format (e.g., including video format), another data sequence format, and/or another output format. The output 215b, 215c may be aggregated at one or more devices for being further processed and/or implemented in other downstream algorithms or processes, as may be further described herein.

Alternatively, or additionally, after the training process is complete, the trained parameters and/or tuned hyperparameters 217, or portions thereof, may be stored for being implemented by one or more devices. The trained parameters and/or tuned hyperparameters 217, or portions thereof, may be implemented in other downstream algorithms or processes, as may be further described herein. The trained parameters and/or tuned hyperparameters 217, or portions thereof, may be implemented on the same device on which the training was performed. The trained parameters and/or tuned hyperparameters 217, or portions thereof, may be transmitted or otherwise provided to another device for being implemented. For example, transmitted or otherwise provided to another device or devices that may implement the NN 209b, 209c based on the trained parameters and/or tuned hyperparameters 217. For example, the NN 209b, 209c may be constructed at another device based on the trained parameters and/or tuned hyperparameters 217, or portions thereof. The NN 209b and NN 209c may be configured from the parameters/hyperparameters 217, or portions thereof, to receive respective input data 207b, 207c and to generate respective outputs 215b, 215c. The output 215b, 215c may be generated in one or more formats, such as a tensor, a text format (e.g., a word, sentence, or other sequence of text), a numerical format (e.g., a prediction), an audio format, an image format (e.g., including video format), another data sequence format, and/or another output format. The output 215b, 215c may be aggregated at one or more devices for being further processed and/or implemented in other downstream algorithms or processes, as may be further described herein.

The AI/ML models and/or algorithms described herein may be implemented on one or more devices. For example, the AI/ML 209 may be implemented in whole or in part on one or more devices, such as one or more WTRUs, one or more base stations, and/or one or more other network entities, such as a network server. Example networks in which AI/ML may be distributed may include federated networks. A federated network may include a decentralized group of devices that each include AI/ML. As shown in FIG. 2C, the AI/ML 209b and AI/ML 209c may be distributed across separate devices. Thought FIG. 2C shows two models (e.g., AI/ML 209b and AI/ML 209c), any number of models may be implemented across any number of devices. The AI/ML may be implemented for collaborative learning in which the AI/ML is trained across multiple devices. In another example, the AI/ML may be trained at a centralized location or device and one or more portions of the AI/ML, or trained parameters and/or tuned hyperparameters, may be distributed to decentralized locations. For example, updated parameters or hyperparameters may be sent to one or more devices for updating and/or implementing the AI/ML thereon.

Acronyms including Federated Learning (FL), Mobile Termination (MT), Non-Access Stratum (NAS), NAS Mobility Management (NAS-MM), NAS Session Management (NAS-SM), Wireless Transmit Receive Unit (WTRU), and/or WTRU Route Selection Policy (WTRU RSP) may be used herein. AI/ML model transfer may be enabled. Analytics and/or predictions may assist an AI/ML operation. The analytics and/or predications may be sent to a WTRU, for example from a 5G system (5GS).

A WTRU may receive analytics and/or predictions that, for example may assist an AI/ML operation running on the 5GS. Additionally, or alternatively, the AI/ML operation may run on the WTRU. An IEAF may provide information (e.g., additional information beyond analytics Identities and/or the same information) in a different format. For example, other parameters, such as traffic categories, may be provided. The IEAF may utilize (e.g., require) other information to enable collection of analytics. Information may include one or more of traffic categories, data network names (DNN), and/or S-NSSAI (Single-Network Slice Assistance Information)), for example to be used as (e.g., additional) filtering information from NWDAF.

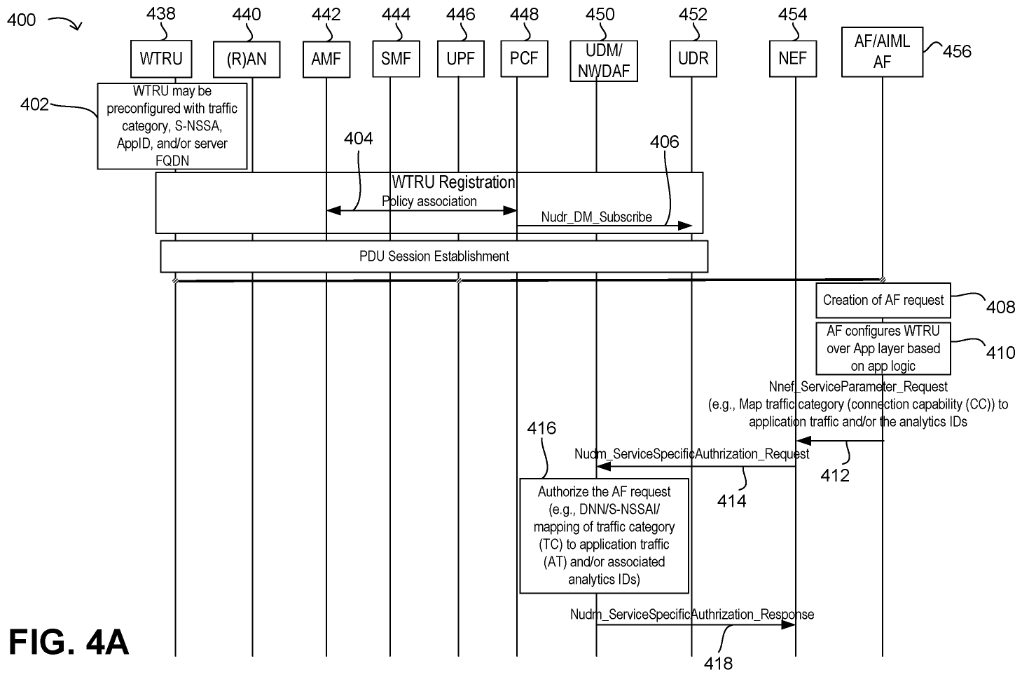

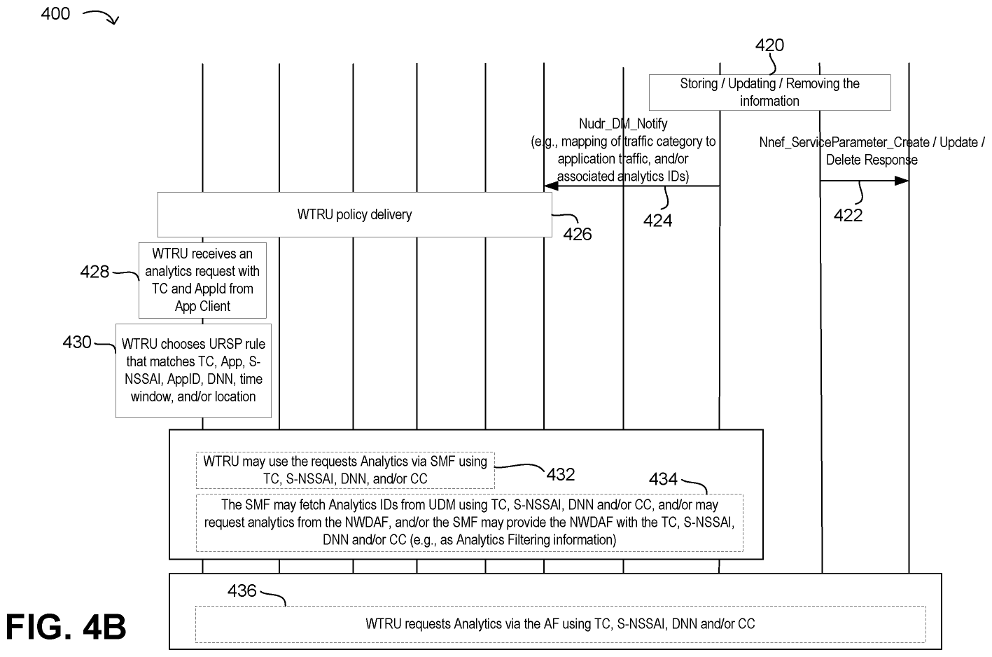

One or more entities may be implemented in a network to perform operations as described herein. For example as shown in FIGS. 4A and 4B, the network or system 400 may include one or more of a WTRU 438, a (R) AN 440, an AMF 442, a SMF 444, a UPF 446, a PCF 448, a UDM/NWDAF 450, a UDR 452, a NEF 454, and/or an AF/AIML AF 456.

There may be an indication of whether the WTRU data exposure client (DEC) should be configured with information (e.g., further information and/or the same information using a different format, and/or different information elements). For example, a DEC may utilize (e.g., require) configuration information, for example in the form of a traffic category and/or connection capability to request authorized analytics (e.g., to request network congestion in a particular area) via IEAF.

The application client (AC) and/or the DEC may determine the scope of functionality. For example, the AC and/or the DEC may determine whether the DEC may be an enhanced edge enable client (EEC). A configuration including information to enable the WTRU to communicate with the IEAF and/or authorization to enable the WTRU to access (e.g., sensitive) network performance data (e.g., IEAF address, analytic ID, authentication and authorization information) may be in a WTRU application client and/or the DEC. Additionally, or alternatively, a mechanism to determine how to configure the information is provided (e.g., is it preconfigured in the WTRU and/or pushed over a data connection).

The DEC may interpret the AC request, for example even if the S-NSSAI is not provided by the client. For example, The WTRU application client may provide S-NSSAI, and/or which S-NSSAI the WTRU application client is provided.

The AF (e.g., IEAF/DCAF) address may be obtained from the WTRU ID, for example without using NRF (e.g., using other NF such as UDR). Maintaining an association (e.g., mapping) between the WTRU ID and the WTRU ID serving DCAF may be achieved via UDR (e.g., instead of NRF).

AI/ML traffic may be identified, for example even if explicit awareness of AI/ML operation type is not provided to the 5GS. 5GC may be (e.g., may need to be) explicitly aware of the application AI/ML operation type. 5GS may determine a WTRU capability to receive network analytics and/or predictions, and/or associated AILM operations (e.g., without using the AI/ML operation type). A WTRU may indicate the WTRU's capability, for example to 5GC, to support an (e.g., specific) application AI/ML operation type and/or an associated granularity.

The network may control WTRU access to resources, for example supporting a particular type of traffic. For example, the 5GS may authorize, and/or be able to authorize, a (e.g., specific) WTRU to participate in an (e.g., specific) application AI/ML operation (e.g., WTRU may not have the right subscription to consume the network resources to support the operation).

GMSA requirements to support traffic categories may be described herein.

A GSMA (e.g., GSM Association) may request 3GPP support for traffic categories. Traffic categories may represent traffic generated by applications including one or more of gaming, video streaming and/or applications related to enterprise services. Traffic categories may be included in the (e.g., existing) WTRU RSP (e.g., WTRU route selection policies), for example within the traffic descriptors.

Route selection guidance through traffic categories may be described herein. For example, mechanisms to use AF route selection guidance to configure WTRU RSP rules may be described. The RSP rules may be used to select one or more of (e.g., specific) data networks, and/or network slice combinations, which for example may support an AI/ML application that better fits the needs of the AI/ML client in the WTRU.

The AF may guide the 5GS to set up WTRU route selection policies (WTRU RSP). The WTRU RSP may be used to determine (e.g., appropriate) S-NSSAI and/or DNN combinations, for example associated with a specific traffic condition. The WTRU RSP may be used to characterize AI/ML operation traffic.

Additionally, or alternatively, examples may address inclusion of traffic categories within WTRU RSP rules. Traffic categories may represent (e.g., specific) traffic, for example running in operator's networks. Traffic categories may be assigned a standardized value and/or a mobile network operator (MNO) specific value, for example to (e.g., uniquely) identify and/or categorize the traffic generated by any active application in a consistent manner, and/or may be included in the (e.g., existing) WTRU route selection policies (RSP) for example within the traffic descriptors.

Analytics filtering may be described herein. Network data analytics may be requested by using an analytics ID and/or analytics filtering information which, for example may indicate the conditions to be fulfilled for reporting analytics information. Parameter types and/or values may enable selection of which type of analytics information is requested.

WTRU RSP rules may be described herein. A WTRU may use one or more WTRU RSP rules to determine the desired characteristic(s) for a PDU session. The PDU session may carry the application traffic, for example, when traffic is initiated by a WTRU application. Characteristics of a PDU session may include one or more of the DNN, S-NSSAI, and/or session and service continuity (SSC) mode that, for example may be associated with the PDU session.

A WTRU RSP rule include a policy that, for example may be used by the WTRU to determine how to route outgoing traffic. Traffic may be routed to a (e.g., established) PDU session. Additionally, or alternatively, traffic may be offloaded to non-3GPP access outside of a PDU session. Additionally, or alternatively, traffic may be routed via a ProSe Layer-3 WTRU-to-network relay, for example outside a PDU session. Additionally, or alternatively, traffic may trigger the establishment of a PDU session.

One or more WTRU RSP rule(s) may include multiple (e.g., two) parts. A first part of the WTRU RSP rule may include a traffic descriptor that, for example may be used to determine when the rule is applicable. A WTRU RSP rule may be determined to be applicable when one or more (e.g., every) component in the traffic descriptor matches the corresponding information from the application. A second part of the WTRU RSP rule may include a list of route selection descriptors (RSD). The list of route selection descriptors may contain one or more route selection descriptors. The RSDs may be listed in priority order and/or may describe the characteristics of a PDU session that, for example may be used to carry the uplink application data. Characteristics of a PDU session may include one or more of SSC Mode, DNN, and/or S-NSSAI. Additionally, or alternatively, the RSD may include a non-seamless offload indication that, for example may indicate that the traffic may be sent via non-3GPP access (e.g., WiFi) and/or outside of one or more (e.g., any) PDU session.

The WTRU may evaluate the WTRU RSP rules in an order of rule precedence and/or determine if the application matches the traffic descriptor of one or more (e.g., any) WTRU RSP rule(s), for example for every detected (e.g., newly detected) application. The WTRU may select a route selection descriptor within a WTRU RSP rule, for example in the order of the route selection descriptor precedence. Additionally, or alternatively, the WTRU may select a route selection descriptor within a WTRU RSP rule when a WTRU RSP rule is determined to be applicable for a given application.

A WTRU may determine if there is an existing PDU session that matches one or more (e.g., all) components in the selected route selection descriptor, for example when a valid route selection descriptor is found. A WTRU may associate the application to the existing PDU session (e.g., the WTRU routes the traffic of the detected application on this PDU session), for example, when a matching PDU session exists. A WTRU may try to establish another PDU session using the values specified by the selected route selection descriptor, for example, if none of the existing PDU sessions matches the RSD.

The WTRU may attempt to use a WLAN access network to transmit the data outside of any PDU session, for example, if the RSD includes a non-seamless offload indication. One or more WLANSP rules may be used to select the WLAN access network.

The WTRU may re-evaluate the WTRU RSP rules and/or associate the traffic from the application with a different PDU session, for example, once traffic from an application is associated with a PDU session. For example the WTRU may re-evaluate the WTRU RSP rules and/or associate the traffic from the application with a different PDU session, based on an event and/or trigger. An event and/or trigger for WTRU RSP re-evaluation may include an implementation dependent re-evaluation timer and/or the WTRU establishing access to a Wi-Fi network that, for example may provide internet access without using the 5G System (e.g., non-seamless offload becomes possible).

A traffic descriptor may include one or more of an application descriptor, an IP descriptor, a domain descriptor, a non-IP descriptor, a DNN, and/or a connection capability. An IP descriptor may include a destination IP 3 tuple(s) (e.g., an IP address and/or IPv6 network prefix, port number, protocol ID of the protocol above IP).

A traffic descriptor may include one or more connection capabilities. The WTRU may determine that the application identifiers identify the applications requesting access to the connection capabilities, for example, if a traffic descriptor lists one or more application identifiers together with one or more connection capabilities. Examples may include one or more of IMS, multimedia messaging service (MMS), secure user plane location (SUPL), Internet, and/or operator specific connection capability values.

Operator-specific traffic categories may be specified, for example using connection capability value ranges. Values may not be standardized values and/or there may not be details regarding how an application may request an operator-specific traffic category/connection capability, for example, for matching to a traffic descriptor.

An application may request connection capabilities, for example when communicating to an Operating System (OS). The request may be OS specific. An OS may map an OS specific value, for example provided by the application to a standardized value. Additionally, or alternatively, the OS may map the OS specific value provided by the application to a standardized value to enable the application to associate its application ID to a standardized connection capability.

An application may use traffic categories to signal intended connection capabilities, for example as an implementation option. Alternatively, or additionally, the application may use traffic categories when communicating to an OS. The OS may further translate intended connection capabilities into (e.g., concrete) connection capabilities. Connection capabilities (e.g., concrete connection capabilities) and/or translation into (e.g., concrete) connection capabilities may enable the OS vendor to offer a traffic category, for example matching reserved connection capability value(s).

Functionality may be utilized to determine how the WTRU may be configured with information that may enable the WTRU to request relevant/appropriate analytics, for example from the network and/or to support AI/ML operation traffic running on the 5GS. Additionally, or alternatively, functionality may be utilized to determine how the WTRU and/or the network identify, characterize and/or communicate information that, for example may enable the WTRU and/or network to handle AI/ML operation traffic without signaling (e.g., explicitly signaling) the AI/ML operation type (e.g., when configuring the WTRU with relevant analytic ID and/or AI/ML server address, requesting analytics and predictions, and/or when determining whether the WTRU is allowed to access resources to support a particular traffic type). The traffic category may include one or more of gaming, video (e.g., video recognition), digital twin, and/or a connection capability. Connection capabilities may include one or more of an operator specific AI/ML (e.g., operator specific AI/ML-1, operator specific AI/ML-2, and/or operator specific AI/ML-3. Additionally, or alternatively, functionality may still be needed to determine how and if the WTRU request of analytics and/or predictions from the network should be authorized. A gaming traffic category may be associated with federated learning. A video (e.g., video recognition) traffic category may be associated with model distribution. A digital twin traffic category may be associated with operation splitting.

Embodiments may be provided herein for enabling an AI/ML application running in a WTRU to request network analytics, for example from a 5G cellular network. Traffic categories or connection capabilities may be used, for example as analytics filter information. Additionally, or alternatively, statistics and/or predictions may be used (e.g., in the WTRU) to optimize an AI/ML operation, for example a specific AI/ML operation.AI/MLAI/ML An AI/ML application may opt out of a federated learning group, for example If the AI/ML application knows that the QoS on a PDU session running AI/ML traffic is going to drop below a threshold (e.g., which may prevent a straggler for that group).

The traffic categories and/or connection capabilities may or may not (e.g., currently) support AI/ML operations, for example to obtain AI/ML analytics. Requesting network data analytics using application AI/ML operation types as analytic filtering information may or may not be supported, for example by a traffic category, connection capability, and/or parameter. As disclosed herein, the WTRU may use traffic categories and/or connection capabilities to signal intent to request network data analytics, for example from the 5GS. An AI/ML application running in the WTRU may be configured, for example by an application service provider. The AI/ML application may be configured with a mapping of an AI/ML operation, for example model distribution and/or federated learning. The mapping of the AI/ML operation may be to a traffic category and/or to a connection capability, for example one or more of those in Table 1 and/or as herein. Table 1 shows example mappings of application AI/ML operations to traffic categories and/or connection capabilities.

TABLE 1

| AI/ML operation | | | Relevant Network |
|---|---|---|---|
| type/characteristic | Traffic Category | Connection Capability | Analytics |
| Federated Learning | Gaming | Operator Specific - | Network Performance |
| | | AI/ML-1 | |
| Model Distribution | Video recognition | Operator Specific - | WTRU Communications |
| | | AI/ML-2 | |
| Operation Splitting | Digital Twin | Operator Specific - | QoS Sustainability |
| | | AI/ML-3 | |

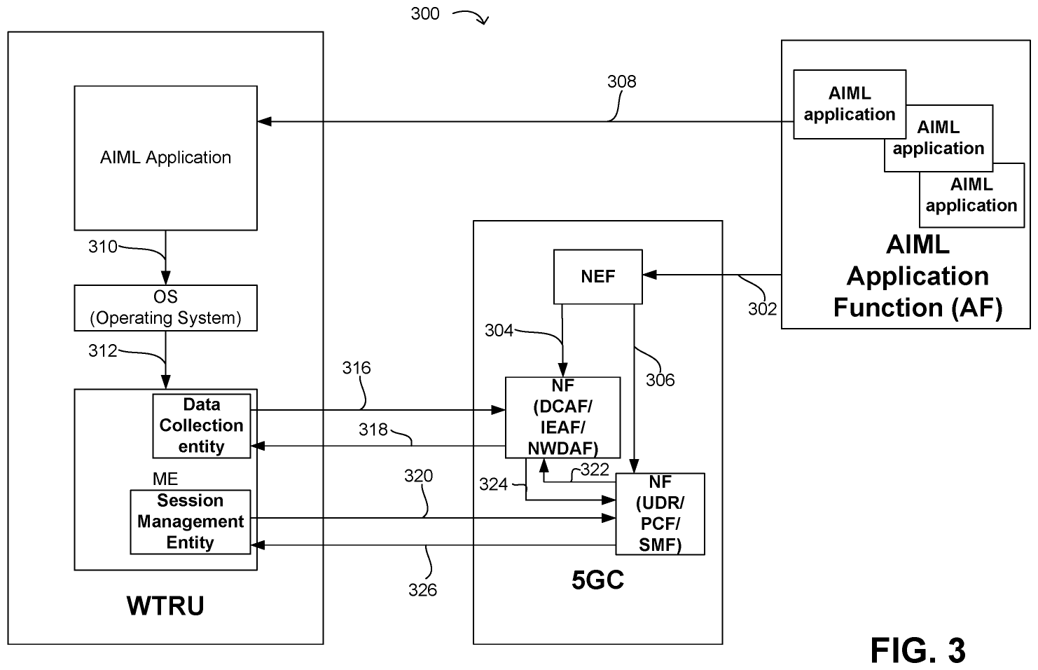

FIG. 3 is an example flow diagram of a system 300 to request network data analytics. At 302, 304, and/or 306 an AI/ML application function may configure data analytic mappings in a data collection function (e.g., at 304) and/or a NF (e.g., UDR (e.g., at 306)). One or more (e.g., of these) functions may reside within the operator's domain. Mappings may be used at 316 and/or 320, for example to derive (e.g., applicable) network data analytics. Network data analytics may be requested from the network analytics function.

The WTRU may receive a configuration from the network that includes an association between (AI/ML) operation type(s) and traffic categories that, for example may (e.g., each) correspond to an AI/ML operation traffic category and/or another parameter. For example, at 308 the AI/ML application function may provide a mapping of (e.g., relevant) network analytics to a traffic category and/or a connection capability. Alternatively, or additionally, the AI/ML function may provide other ancillary parameters, for example one or more of an applicable network slice (e.g., applicable S-NSSAI), DNN, OSid, application ID, and/or the AF address of the data collection function (e.g., the IEAF) at the network side. The information and/or parameters may be provided by the AI/ML application function, for example when there is a data connection to the AI/ML client in the WTRU and/or the information is preconfigured in the AI/ML client in the WTRU. Mappings may be aligned with those provided to the 5GC, for example in steps 304 and/or 306, (e.g., similar, or identical information may be provided to both the AI/ML client in the WTRU and/or applicable NFs in the 5GC).

At 310, the AI/ML client may request data connectivity and/or establishment of a PDU session from the OS, for example to enable a data connection toward the AI/ML application function. Alternatively, or additionally, the AI/ML client may request data connectivity and/or establishment of a PDU session from the OS at any time. The AI/ML client may request network data analytics from the 5GC, for example if the AI/ML client requires network data analytics. The AI/ML may provide (e.g., applicable) traffic categories and/or connection capabilities. The AI/ML may provide other parameters, for example one or more of DNN, application Id, S-NSSAI, and/or an (e.g., clear) indication that network analytics are required. For example, the presence of a connection capability related to AI/ML traffic may be used to indicate (e.g., implicitly flag) the need for network data analytics associated with the connection capability, for example without having to explicitly request these network data analytics. The AI/ML application request may additionally, or alternatively indicate whether network analytics should be requested via a user plane (e.g., using the AF data collection addressed provided by the AI/ML application function) and/or via a control plane (e.g., using an AI/ML specific connection capability). Although the AI/ML client request may be OS specific, the request may be implemented using attention (AT) commands. For example, the OS specific request from AI/ML client may be mapped by the OS onto a cocreated AT Command.

At 312 the OS may issue an AT command and/or applicable implementation specific message, for example to a WTRU 3GPP 5G modem. The request may include information regarding the AI/ML client request, for example using the modem vendor specific application programming interface (API).

The WTRU may determine to request and/or request the establishment of a PDU session, for example if there is not already an existing PDU session satisfying the request from the AI/ML client. An entity, for example an entity discussed herein, may determine to request and/or request the establishment of the PDU session. For example, the entity may include one or more of a data collection entity and/or a session management entity. The PDU session may match URSP rules, for example found to be applicable to the AI/ML client request (e.g., matching the connection capability communicated by the AI/ML client). The WTRU may include the connection capability provided by the AI/ML client in the request. Alternatively, or additionally, if a data collection client is present for example, the WTRU may decide to send the network data analytics request over the user plane. Sending network data analytics over the user plane may utilize a data collection application function address, for example provided by the AI/ML client. The WTRU choosing/determining to request network data analytics using a PDU session request and/or via the data collection entity may be based on whether the data collection application function addressed is present and/or whether the data collection entity in the WTRU is present.

At 316 a request may be sent over the PDU session established to convey AI/ML specific traffic, for example if the WTRU chooses to use the data collection entity. Additionally, or alternatively, the request may be sent using the connection capability, for example to match an applicable URSP rule.

At 318 the data collection application function may use the connection capability and/or mappings, for example configured at 304, to request applicable network data analytics. A result may be sent back to the data collection entity in the WTRU.

At 320 the WTRU may include connection capability in the PDU session establishment, for example if the WTRU decides to request the establishment of a PDU session. The inclusion of the connection capability may signal to the SMF a request for network data analytics associated with the connection capability.

At 322 and/or 324 the SMF may obtain a list of applicable network data analytic IDs, for example from the UDR. This information (e.g., the list of applicable network data analytic IDs) may be used to request network data analytics from the NWDAF.

At 326 the SMF may decide to provide the requested network data analytics (e.g., using the associate PDU session establishment accept message), for example depending on whether network data analytics are available at the SMF when the WTRU requests them. Additionally, or alternatively, the SMF may use PDU session modification procedures. The SMF may include network data analytics with (e.g., within) the protocol configuration options (PCO) field and/or any other parameter. Network data analytics may be used by the WTRU to determine the level of participation in an existing and/or future application AI/ML operation, for example depending on the connection capability provided by the WTRU. Network analytics may include one or more of network load (e.g., in an area of interest), QoS sustainability analytics, WTRU mobility, WTRU communications analytics, and/or quality of experience analytics. The AI/ML client in the WTRU may decide to not participate in a federated learning operation. For example, the AI/ML client may decide to not participate in a federated learning operation if the AI/ML client is about to handover to an area where congestion is likely to occur and/or if the QoS characteristics of the data connection will not satisfy the requirements for the application AI/ML operation to transfer large amount of data between the AI/ML application client in the WTRU and the AI/ML application at the application function at the network side. The WTRU may determine an AI/ML service operation type, for example to be operated by an AI/ML application client on the WTRU.

Some examples provided herein may use/leverage a concept to associate a traffic category and/or connection capability to application a AI/ML operation traffic and/or to an application AI/ML operation type traffic. The AI/ML operation traffic may be identified through a traffic category and/or connection capability. Additionally, or alternatively the AI/ML operation type may be identified using one or more components from the traffic descriptor. One or more components from the traffic descriptor may be used as analytics filtering information (e.g., traffic category may be and/or may include AI/ML traffic. A (e.g., specific) AI/ML operation type may be (e.g., further) identified through one or more of a S-NSSAI, OSid, connection capability and/or application ID.

Additionally, or alternatively, a specific application AI/ML operation type may be identified using a traffic category. A traffic category may include one or more of federating learning, model distribution, and/or a split AI/ML operation. The traffic category may additionally, or alternatively, include the at least one parameter. The at least one parameter may include an application descriptor and/or a connection capability parameter that, for example may be associated with an AI/ML value.

The WTRU may transmit, for example to a network element, a request for analytics and/or a prediction related to the AI/ML service operation type. The request may include an indication of the traffic category and/or the at least one parameter. The WTRU request for analytics and/or predictions from the network may be authorized by a mechanism (e.g., via Oauth 2.0 authorization token). A token may be requested by the AF from the network and/or delivered to the WTRU, for example along with a policy. The request message may include the authorization token, for example when the WTRU requests the network analytics and/or prediction(s). The network may validate the request, for example using the token provided by the WTRU. The WTRU may receive the analytics and/or prediction related to the AI/ML service operation type, for example in response to the request. Additionally, or alternatively, the analytics and/or prediction may indicate a quality of service (QOS) of the traffic to be generated by the client applications on the network over a period of time. The WTRU may receive mapping of the AI/ML operation type over the user plane. The WTRU may receive mapping of the AI/ML operation type from an application function (AF).

Associating and/or mapping of a traffic category to an (e.g., application of) AI/ML operation type may be described herein. The AF may provide the 5GC with a mapping of a traffic category associated with an application AI/ML operation type. Traffic category may be equivalent to AI/ML traffic. Characteristics of the (e.g., specific) application traffic may be associated with an AI/ML operation type. The mapping may obviate the need for the 5GC to require knowledge (e.g., explicit knowledge) of AI/ML operation types. Additionally, or alternatively, the traffic that is running on a (e.g., particular) PDU session may be obtained by the 5GC and/or may be associated to a traffic category (e.g., AI/ML traffic). The AF may provide application traffic, including for example packet flow descriptions. Additionally, or alternatively, the AF may associate analytics IDs and/or analytics filters with application traffic. The analytics IDs and/or analytics filters may indicate one or more conditions to be fulfilled for reporting analytics information (e.g., area of interest and/or time window).

The WTRU may match the AI/ML service operation type to the traffic category or the at least one parameter, for example based on the configuration. The at least one parameter may be related to traffic generated by one or more client applications on the network. The WTRU may match the AI/ML service operation type to the traffic category and/or the at least one parameter, for example based on a route selection policy (RSP) rule matched against a traffic category. The WTRU may determine a route selection policy based on the analytics and/or prediction, for example related to the AI/ML service operation type. The at least one parameter may include at least one of a connection capability, an OSid, an App ID, and/or an S-NSSAI/DNN. The traffic category may indicate at least one AI/ML value. The at least one AI/ML value may indicate at least one of a model distribution value, a federated learning value, and/or an operation split value.

A WTRU may provide (e.g., optionally provide) a connection capability value, for example to (e.g., further) identify the application AI/ML operation traffic and/or map both a traffic category and/or connection capability to a particular application traffic for example, when the AF provides the 5GC with the mapping of the traffic category to application traffic. Application traffic may be associated with characteristics including one or more of application ID, S-NSSAI, DNN, Time Window, and/or Aol (Area of Interest).

The AF may determine that an application AI/ML operation traffic, for example supporting FL operations, may be tagged with (e.g., associated with) a traffic category. The tag may include AI/ML traffic. A connection capability may include AIM-Loption_1. The AIM-Loption_1 may refer to, for example, federating learning traffic, and/or may map two or more values (e.g., DNN-1 and/or S-NSSAI-2) with a (e.g., specific) time window and/or location. Additionally, or alternatively, the AF may provide the 5GC with a set of analytic IDs that are relevant/valid for one or more traffic category (its) and/or connection capabilities. The AF may provide the 5GC with the set of analytic IDs by using procedures described herein. The AF may determine that a AI/ML Operation with specific QoS requirements may be tagged with a traffic category associated with a (e.g., specific) application traffic.

An association of traffic category to an application traffic descriptors may be described herein. Table 2 provides examples of traffic descriptors that may be used by one or more WTRUs.

TABLE 2

| | | | Example PCF | |
|---|---|---|---|---|
| | | | permitted to | |
| Information | | Example | modify in a | Example |
| name | Example Description | Category | WTRU context | Scope |
| Traffic | Traffic descriptor | Mandatory | | |
| descriptor | components, for example for | (e.g., NOTE 3) | | |
| | a URSP rule | | | |
| Application | May include OSld and/or | Optional | Yes | WTRU context |
| descriptors | OSAppld(s). (e.g., NOTE 2) | | | |
| IP descriptors | Destination IP 3 tuple(s) | Optional | Yes | WTRU context |
| (NOTE 5) | (e.g., one or more of IP | | | |
| | address, IPv6 network prefix, | | | |
| | and/or port number, protocol | | | |
| | ID of the protocol above IP). | | | |
| Domain | May include FQDN(s) or a | Optional | Yes | WTRU context |
| descriptors | regular expression which, for | | | |
| | example may be used as a | | | |
| | domain name matching | | | |
| | criteria (e.g., NOTE 6). | | | |
| Non-IP | Example descriptor(s) for | Optional | Yes | WTRU context |
| descriptors | destination information, for | | | |
| (NOTE 5) | example of non-IP traffic | | | |
| DNN | May be matched against the | Optional | Yes | WTRU context |
| | DNN information, for | | | |
| | example provided by the | | | |
| | application. Different DNNs | | | |
| | and/or S-NSSAls may be | | | |
| | combined. A combination | | | |
| | may be used to identify the | | | |
| | Al/ML operation type for a | | | |
| | (e.g., this) traffic category. | | | |
| Connection | This is matched against the | Optional | Yes | WTRU context |
| capabilities | information provided by a | | | |
| | WTRU application when it | | | |
| | requests a network | | | |
| | connection with certain | | | |
| | capabilities. (e.g., NOTE 4), | | | |
| | (e.g., NOTE 9) | | | |
| Traffic | May be matched against the | Optional | Yes | WTRU context |
| category | traffic category ID, for | | | |
| | example provided to the | | | |
| | WTRU by the AF/PCF. The | | | |
| | AF/PCF may use the traffic | | | |
| | category, for example to | | | |
| | identify the AI/ML operation | | | |
| | traffic. | | | |
| Analytics IDs | List of example associated | Optional | Yes | WTRU context |
| | analytic IDs allowed for a | | | |
| | (e.g., specific) TC | | | |
| Route | May include examples of the | Optional | | |
| Selection | route validation criteria | | | |
| Validation | components | | | |
| Criteria | | | | |
| Time window | May include a time window | Optional | Yes | WTRU context |
| | when matching traffic is | | | |
| | allowed. The RSD may not | | | |
| | be considered to be valid, for | | | |
| | example if the current time is | | | |
| | not in the time window (e.g., | | | |
| | when the AI/ML operation is | | | |
| | FL). The time window may | | | |
| | be based on the time window | | | |
| | required by the FL operation, | | | |
| | for example to complete the | | | |
| | FL operation. | | | |
| Location | The WTRU location where | Optional | Yes | WTRU context |
| criteria | the matching traffic is | | | |
| | allowed. The RSD rule is not | | | |
| | considered to be valid if the | | | |
| | WTRU location does not | | | |
| | match the location criteria. | | | |
| | The location criteria are used | | | |
| | to validate where a particular | | | |
| | AI/ML operation type is | | | |
| | allowed to operate. E.g., for | | | |
| | a particular location the RSD | | | |
| | rule may be valid for AI/ML | | | |
| | operation of type FL but not | | | |
| | for Model Distribution | | | |

NOTE 1:
Each route selection descriptor in the list may have a different precedence value.
NOTE 2:
At least one of the route selection components may be present.
NOTE 3:
When the subscription information contains one or more (e.g., only one) S-NSSAI in UDR, the PCF may not (e.g., may not need to) provide the WTRU with S-NSSAI in the network slice selection information. The “match all” WTRU RSP rule may include one S-NSSAI (e.g., at most).
NOTE 4:
Other components may not be included in the route selection descriptor, for example if this indication is present in a route selection descriptor.
NOTE 5:
The SSC Mode 3 may be used (e.g., only be used) when the PDU session type is IP.
NOTE 6:
The route selection descriptor may not be considered valid unless one or more (e.g., all) of the provided validation criteria are met.
NOTE 7:
Inclusion of the validation criteria in a roaming scenario may not be considered.
NOTE 8:
When the PDU session type is ethernet and/or unstructured for example, this component may be present.
NOTE 9:
Connection capabilities may describe application traffic when paired with a particular traffic category (e.g., traffic category may be equivalent to AI/ML traffic and/or connection capability (e.g., AI/ML_option_1).

An AF may provide the 5GS one or more mapping parameters described herein, for example using the application guidance for WTRU RSP determination procedure (e.g., as described herein). The AF may provide the 5GS one or more mapping parameters by using a service parameter operation, for example with enhancements as described herein.

A WTRU may be configured (e.g., preconfigured) with one or more of a traffic category, S-NSSA, AppID, and/or a server FQDN. A WTRU registration may be transmitted to one or more of a WTRU, RAN, AMF, SMF, UPF, PCF, UDM/NWDAF, and/or UDR. The WTRU registration may include a policy association. The WTRU registration may include a Nudr_DM_Subscribe transmission. A PDU session establishment may be transmitted to one or more of a WTRU, RAN, AMF, SMF, UPF, PCF, UDM/NWDAF, and/or UDR. The WTRU may receive a WTRU policy delivery, for example with enhancements as described herein. The WTRU may receive an analytics request with TC and/or AppID from App client. The WTRU may choose one or more WTRU RSP rule(s) that are associated with one or more of TC, App, S-NSSAI, AppID, DNN, time window, and/or location. The WTRU may use the request(s) analytics via SMF, for example using one or more of TC, S-NSSAI, DNN, and/or CC. The WTRU may request(s) analytics via the AF, for example using one or more of TC, S-NSSAI, DNN, and/or CC.

The WTRU (e.g., application client in the WTRU) may receive the WTRU (e.g., over the User Plane) mapping of an AI/ML operation type to a traffic category, for example from an AF. The traffic category may correspond to one or more of the AI/ML operation, traffic category, the S-NSSAI/DNN combination, and/or OSId and application ID, for example to identify the AI/ML operation type. The WTRU may receive the WTRU mapping of the AI/ML operation type from an AF. The application client WTRU may use the mapping when, for example requesting a connection from the NAS layer.

The WTRU may match the traffic category, for example provided by the AI/ML application client, to the associated WTRU RSP rule and/or use the matched traffic category value to request analytics and/or predictions from the 5GC.

Referring again to FIGS. 4A and 4B, an example 400 of WTRU RSP based configuration of traffic categories to application traffic is shown. For example, a WTRU may receive a configuration. The configuration may include at least one of an AI/ML operation type association to a traffic category. The traffic category may correspond to an AI/ML operation traffic category and/or at least one parameter. The traffic category may include the at least one parameter. The at least one parameter may include an application descriptor and/or a connection capability parameter that, for example may be associated with an AI/ML value. At 402 an AI/ML app client in the WTRU may be configured with mapping of application AI/ML operation types to one or more (e.g., specific) traffic category value(s) and/or connection capability value(s). Additionally, or alternatively, one or more other parameters may be used to further adjust the mapping. One or more of the S-NSSAI, DNN, AppID Server FQDN, and/or OSId may (e.g., also) be configured in the AI/ML app client as part of the mapping.

At 404 and/or 406 the WTRU may register to the system and/or establish a PDU session to connect to the AI/ML AF. At 408 the AF may determine to update the WTRU with mapping of traffic categories to AI/ML operation types. To achieve this for example, the AF may associate one or more traffic categories to application AI/ML operation types and/or may map one or more of the traffic categories to application traffic.

At 410 the WTRU may negotiate a configuration of mapping of traffic categories (e.g., and App ID and/or connection capabilities) to application AI/ML operations with the AF (e.g., over the User Plane) AI/ML. At 412 the AF may provide the 5GC with one or more mappings of traffic categories and/or connection capabilities to (e.g., specific) application traffic. Additionally, or alternatively, the AF may provide analytics IDs associated with the traffic category and/or with the NSWDAF instance ID. The AF may obtain one or more analytics IDs by subscribing to (e.g., relevant) NWDAF services (e.g., through NEF). The AF may register analytics ID(s) in the UDM subscriber record, for example using one or more of the traffic category and AppID, S-NSSAI, connection capability, and/or OSid as a data key. For example, at 414, 416, and/or 418 the NEF may request authorization from the UDM through a service specific information. Authorization may include one or more of a traffic category, connection capability, service type (e.g., AF guidance for mapping of traffic category to application traffic), and/or associated analytics IDs. The WTRU may match the AI/ML service operation type to the traffic category or the at least one parameter, for example based on the configuration. The at least one parameter may be related to traffic generated by one or more client applications on the network. The WTRU may match the AI/ML service operation type to the traffic category and/or the at least one parameter, for example based on a route selection policy (RSP) rule matched against a traffic category. The traffic category may indicate at least one AI/ML value. The at least one AI/ML value may indicate at least one of a model distribution value, a federated learning value, and/or an operation split value.

At 420 the NEF may store the AF request in the UDR as per current procedure. At 422 the NEF may respond to the AF, for example with a Nnef_ServiceParameter_Create/Update/Delete Response. At 424 the UDR may notify the PCF regarding the parameter updates provided by the AF. At 426 the PCF may deliver the policy that, for example may indicate the traffic category ID and/or one or more analytics IDs associated to the traffic category included in the traffic descriptor. At 428 an AI/ML application client may request connectivity and/or the AI/ML application client may provide the TC, AppID and/or other ancillary parameters. At 430 the WTRU may receive a connection request from an AI/ML application client (AC) and/or the WTRU may use the policy to modify and/or match the traffic category and/or ancillary parameters provided by the AC (e.g., connection capability, S-NSSAI and/or AppID, OSid).

A conditional-request for analytics using a control plane solution (e.g., through SMF) may be described herein. The WTRU may request analytics and/or predictions from the network, for example at 432. The WTRU may replace the application AI/ML operation type with the traffic category and/or ancillary parameters.

At 434 the SMF may use the parameters described herein to identify the analytic IDs of one or more WTRUs. The SMF may use the parameters to obtain the relevant analytics ID(s) associated with the traffic category provided by the WTRU, for example by requesting this information from the UDM. The UDM may use one or more of the traffic category, the connection capability, OSid, AppID, and/or S-NSSAI, as data keys. For example, the at least one parameter may include at least one of a connection capability, an OSid, an App ID, and/or an S-NSSAI/DNN. The WTRU may determine a route selection policy based on the analytics and/or prediction, for example related to the AI/ML service operation type.

Rule precedence may be used to prioritize traffic with a specific traffic category. For example, rule precedence may be used when one or more (e.g., some) of the components of a rule where a traffic category is included are also part of another rule (e.g., domain descriptor and/or IP tuple).

A conditional-request for analytics, for example using a user plane solution (e.g., through AF) may be described herein. At 436 the WTRU may request analytics and/or predictions from the network, using procedures described herein and/or replacing specific analytics ID(s). The WTRU may request analytics and/or predictions from the network with the traffic category and/or ancillary parameters, for example to help the SMF identify the (e.g., relevant) analytic IDs.

WTRU RSP rules to obtain the analytic IDs that are accessible to an application client may be described herein. A WTRU that hosts an application client may use WTRU RSP rules and/or information obtained from the application client, for example to determine the characteristics of a PDU session. The characteristics may be used by the application client to perform AI/ML operations and/or to obtain, for example from the network, a list of analytics IDs that are accessible to the application client. The list of analytics IDs may be provided to the application client.

A connection capability in a traffic descriptor of a WTRU RSP rule may be assigned a value of AI/ML. A (e.g., the same) traffic descriptor may include one or more application identifiers. The WTRU RSP rule may include one or more RSDs. Each of the one or more RSD(s) may include a DNN/S-NSSAI combination that, for example may be used to establish a PDU session that can support AI/ML operations. The traffic descriptor may (e.g., further) include one or more operation type values. The operation type values may indicate one or more of model distribution, operation split, and/or federated learning.

An AI/ML application client, for example hosted on the WTRU may provide a traffic descriptor to the NAS layer of the WTRU. The AI/ML application client may provide the traffic descriptor to the MT part of the WTRU, for example by invoking an AT Command (e.g., +CGDCONT). The traffic descriptor may include one or more of an application ID, a connection capability, and/or one or more Operation Type values.

The connection capability value of the traffic descriptor, for example provided by the application client, may be set to AI/ML. The operation type value of the traffic descriptor that, for example is provided by the application client, may be set to one or more of model distribution, operation split, and/or federated learning. The operation type value may indicate which of the three or more operation types the application wants to perform. The operation type value may indicate multiple operation type (e.g., it may indicate that model distribution and/or operation split are desired, but federated learning is not desired). The application client may determine how to set the values of the traffic descriptor as described herein.

The NAS layer may compare the traffic descriptor from the application client against the traffic descriptors of the WTRU RSP rules (e.g., configured in the WTRU) for example, upon receiving the traffic descriptor from the application client. The WTRU NAS layer may determine that (e.g., consider) the traffic descriptor from the application client matches the traffic descriptor of a WTRU RSP rule(s) if the (e.g., two) conditions are met. A first condition may include that the application ID and/or connection capability values of the traffic descriptor from the application client are equal to the traffic descriptor of the WTRU RSP rule(s). A second condition may include that the operation type values of the traffic descriptor from the application client are included in the traffic descriptor of the WTRU RSP rule(s). The operation type values may be considered matching, for example if the application client provides operation type values of one or more of model distribution, and/or operation split, and the traffic descriptor of the WTRU RSP rule includes model distribution, operation split, and/or federated learning.

WTRU NAS layer may use an RSD of the WTRU RSP rule to determine a DNN and/or S-NSSAI combination that, for example may be used to establish a PDU session for the application client's traffic. The WTRU NAS layer may use an RSD of the WTRU RSP rule to determine a DNN and/or S-NSSAI combination once a WTRU RSP rule is determined (e.g., found) to be matching. The WTRU NAS layer may send a PDU session establishment request to the network and/or may include the determined DNN and/or S-NSSAI in the PDU session establishment request. The DNN and/or S-NSSAI value may be used by the network to select an AMF and/or SMF that, for example may serve the AI/ML request. The PDU session establishment request may include the traffic descriptor (e.g., one or more of operation type value(s), application ID, and/or connection capability) that, for example were provided by the application client. The SMF may receive an indication of a WTRU operation (e.g., an operation the WTRU intends to perform), for example in the PDU session establishment request. The indication of the WTRU operation may be including in a traffic descriptor (e.g., one or more of operation type values, application ID, and/or connection capability) in the PDU session establishment request. The SMF may use the traffic descriptor (e.g., one or more of operation type values, application ID, and/or connection capability) to identify the analytic IDs that, for example may be accessed by the WTRU. Additionally, or alternatively, the SMF may provide the analytic IDs to the WTRU in a PDU session establishment accept message.

Additionally, or alternatively, the traffic descriptor may be included in the NAS-MM message. The NAS-MM message be used by the WTRU to send the PDU session establishment request to the network. The AMF may receive an indication of a WTRU operation (e.g., an operation the WTRU intends to perform), for example by including the operation type values in the NAS-MM message. The AMF may use the traffic descriptor to identify the analytic IDs that may be accessed by the WTRU and/or the AMF may provide the analytic IDs to the WTRU, for example in the NAS-MM message that carries the PDU session establishment accept message.

The NAS layer may provide the analytics IDs to the AI/ML application client, for example, when the NAS layer receives the analytic IDs (e.g., that may be accessed by the WTRU). The WTRU may send a NAS-SM message (e.g., a PDU session modification request) to the network, for example to provide the SMF and/or AMF with the traffic descriptor (e.g., one or more of operation type values, application ID, and/or connection capability). The traffic descriptor may be provided by the application client, for example, if the WTRU NAS layer determines that the traffic descriptor from the application client matches the traffic descriptors of a WTRU RSP rule and/or that a selected RSD matches a PDU session is already established. The analytics IDs may be received by the WTRU, for example when the WTRU receives a NAS-MM message from the AMF and/or a NAS-SM (e.g., PDU session modification command) from the SMF.

What is claimed is:

1-20. (canceled)

21. A method implemented by a wireless transmit/receive unit (WTRU), the method comprising:
receiving a mapping, wherein the mapping is a mapping of an artificial intelligence machine learning (AI/ML) service type to a traffic category or an AI/ML service type to at least one parameter, wherein at least one of the traffic category or the at least one parameter is associated with AI/ML traffic, and wherein the at least one parameter is related to traffic generated by a client application on a network;
determining an AI/ML service type to be operated by an AI/ML application client on the WTRU;
matching, based on the mapping, the AI/ML service type to the traffic category or the AI/ML service type to the at least one parameter;
transmitting a request to a network, wherein the request is a request for analytics related to the AI/ML service type or a request for a prediction related to the AI/ML service type, wherein the request comprises an indication of at least one of the traffic category matched with the AI/ML service type or the at least one parameter matched with the AI/ML service type; and
in response to the request, receiving the analytics related to the AI/ML service type or the prediction related to the AI/ML service type.

22. The method of claim 21, wherein matching the at least one of the AI/ML service type to the traffic category or the AI/ML service type to the at least one parameter is based on a route selection policy (RSP) matched against a traffic category, wherein the traffic category indicates at least one AI/ML value, wherein the at least one AI/ML value indicates at least one of a model distribution value, a federated learning value, or an operation split value.

23. The method of claim 22, wherein the at least one parameter comprises at least one of an application descriptor or a connection capability parameter that is associated with the at least one AI/ML value.

24. The method of claim 21, wherein the analytics related to the AI/ML service type or the prediction related to the AI/ML service type indicates a quality of service (QoS) of the traffic to be generated by the client application on the network over a period of time.

25. The method of claim 21, wherein the request for the analytics related to the AI/ML service type or the prediction related to the AI/ML service type is further related to the traffic generated by the client application on the network.

26. The method of claim 21, wherein the mapping of the at least one of the AI/ML service type to the traffic category or the AI/ML service type to the at least one parameter is received over a user plane.

27. The method of claim 21, wherein the mapping of the at least one of the AI/ML service type to the traffic category or the AI/ML service type to the at least one parameter is received from an application function (AF).

28. The method of claim 21, wherein the at least one parameter comprises at least one of a connection capability, an operation system identifier (OSid), an application identifier, or a single-network slice assistance information (S_NSSAI) data network name (DNN) (S-NSSAI/DNN).

29. The method of claim 21, comprising determining a route selection policy based on the request for analytics related to the AI/ML service type or the request for a prediction related to the AI/ML service type.

30. The method of claim 21, wherein the network comprises a session management function (SMF) network entity.

31. A wireless transmit/receive unit (WTRU) comprising:
a processor configured to:
receive a mapping, wherein the mapping is a mapping of an artificial intelligence machine learning (AI/ML) service type to a traffic category or an AI/ML service type to at least one parameter, wherein at least one of the traffic category or the at least one parameter is associated with AI/ML traffic, and wherein the at least one parameter is related to traffic generated by a client application on a network;
determine an AI/ML service type to be operated by an AI/ML application client on the WTRU;
match, based on the mapping, the AI/ML service type to the traffic category or the AI/ML service type to the at least one parameter;
transmit a request to a network, wherein the request is a request for analytics related to the AI/ML service type or a request for a prediction related to the AI/ML service type, wherein the request comprises an indication of at least one of the traffic category matched with the AI/ML service type or the at least one parameter matched with the AI/ML service type; and
in response to the request, receive the analytics related to the AI/ML service type or the prediction related to the AI/ML service type.

32. The WTRU of claim 31, wherein the processor is configured to match the at least one of the AI/ML service type to the traffic category or the AI/ML service type to the at least one parameter based on a route selection policy (RSP) matched against a traffic category, wherein the traffic category indicates at least one AI/ML value, wherein the at least one AI/ML value indicates at least one of a model distribution value, a federated learning value, or an operation split value.

33. The WTRU of claim 32, wherein the at least one parameter comprises at least one of an application descriptor or a connection capability parameter that is associated with the at least one AI/ML value.

34. The WTRU of claim 31, wherein the analytics related to the AI/ML service type or the prediction related to the AI/ML service type indicates a quality of service (QOS) of the traffic to be generated by the client application on the network over a period of time.

35. The WTRU of claim 31, wherein the request for the analytics related to the AI/ML service type or the prediction related to the AI/ML service type is further related to the traffic generated by the client application on the network.

36. The WTRU of claim 31, wherein the processor is configured to receive the mapping of the at least one of the AI/ML service type to the traffic category or the AI/ML service type to the at least one parameter over a user plane.

37. The WTRU of claim 31, wherein the processor is configured to receive the mapping of the at least one of the AI/ML service type to the traffic category or the AI/ML service type to the at least one parameter from an application function (AF).

38. The WTRU of claim 31, wherein the at least one parameter comprises at least one of a connection capability, an operation system identifier (OSid), an application identifier, or a single-network slice assistance information (S_NSSAI) data network name (DNN) (S-NSSAI/DNN).

39. The WTRU of claim 31, wherein the processor is configured to determine a route selection policy based on the request for analytics related to the AI/ML service type or the request for a prediction related to the AI/ML service type.

40. The WTRU of claim 31, wherein the network comprises a session management function (SMF) network entity.
